(19) United States
(12) Patent Application Publication
(10) Pub. No.: US 2018/0238452 A1
(43) Pub. Date: Aug. 23, 2018

(54) MECHANICAL SEAL

(71) Applicants: Stephen Martin Shaw, Rotherham (GB); Andrew Colverson, Rotherham (GB)

(72) Inventors: Stephen Martin Shaw, Rotherham (GB); Andrew Colverson, Rotherham (GB)

(73) Assignee: AES Engineering Ltd., Rotherham (GB)

(21) Appl. No.: 15/903,891

(22) Filed: Feb. 23, 2018

(30) Foreign Application Priority Data
Feb. 23, 2017 (GB) 1702893.7.1

(51) Int. Cl. F16J 15/34; F16J 15/54; F16J 15/16

(52) U.S. Cl. CPC F16J 15/3452; F16J 15/3464; F16J 15/164; F16J 15/54

(57) ABSTRACT

A mechanical seal assembly has rotational and stationary sealing members) and a drive unit, which is axially adjacent one of the sealing members. An energizing member urges the drive unit towards the sealing members. A retainer axially and radially retains one of the sealing members. The drive unit is in contact with one of the rotational and stationary members by way of contacting surfaces which are in the range of 1 and 20 light bands of flatness, inclusive.

### BACKGROUND OF THE INVENTION

### Technical Field of the Invention

The present invention relates, generally, to a mechanical seal which acts to retain effective sealing in varying temperature applications by maintaining the integrity of the mechanical seal between the face and its holder.

### Description of the Prior Art

Mechanical seals are of common place in a multitude of industries for providing a seal between rotating and stationary components. The seal is created by one sealing face rotating against a stationary sealing face. It is a known issue that inserted faces are limited to a certain temperatures before thermal expansion causes the inserted face to become loose within its holder. This problem leads to ineffective sealing between the seal face and its holder which can result in catastrophic seal failure.

From prior art, this problem has been attempted to be rectified through the use of a holder constructed of specific materials of a very similar coefficient of thermal expansion to the seal face material. These materials, in which the seal face is held, are often not resistant to corrosion and/or still expand at slightly different rates in comparison to the seal member material. This limits the applications in which the seal can be installed. In addition, an effective secondary seal can be achieved through the use of an elastomeric or compressive member. However their performance is limited to certain temperatures. These factors limit the applications in which the seal can be installed. This problem can be solved by creating a more effective seal using alternative means.

### SUMMARY OF THE INVENTION

Accordingly, the present invention is directed, but not solely limited, to a mechanical seal assembly for sealing a rotatable shaft to a fixed housing, the mechanical seal comprising rotational components fixed relative to the shaft and stationary components fixed relative to the housing; the one or more rotational components comprise of one or two rotational primary sealing members, each contacting different multiples of springs or one or more energizing elements to provide seal face pressure, The rotational components further comprise means for axially and radially retaining the one or more primary sealing members. The primary sealing members are also driven by the rotational or stationary components. The one or more primary sealing members comprise a secondary seal, which is between (and including) 1 and 20 light bands of flatness concave, convex or concave/convex. All aforementioned parts are housed within a gland to enable easy installation.

Preferably, the axial and radial retaining is achieved by an additional member.

More preferably, the additional member is of annular shape.

More preferably, the additional member may be split into a plurality of sections.

Preferably, the annular-shaped additional member is shaped so that it radially retains the primary sealing member.

Preferably, the inner diameter of the annular additional member is radially offset from the outer diameter of the primary sealing member.

More preferably, the offset allows for thermal expansion of the primary sealing members.

More preferably, the offset can be calculated such that it is optimized.

Preferably, the annular additional member is shaped so that it axially retains the primary sealing member.

More preferably, the axial retention is offset from the primary sealing member.

More preferably, the offset allows for thermal expansion of the primary sealing members.

More preferably, the offset is calculated such that it is optimized.

Preferably, the additional member is adjoined to one or more of the rotating or stationary parts through a fixing method.

More preferably, the fixing method is an interference fit.

More preferably, and alternatively, the fixing method is a shrink fit.

More preferably, and alternatively, the fixing method is a thread.

More preferably, and alternatively, the fixing method is an adhesive.

More preferably, and alternatively, the fixing method is a weld.

More preferably, more than one fixing method may be utilized.

Preferably, the annular member is retained axially located and/or retained by one or more of the rotating or stationary part or parts.

Preferably, the effective secondary seal is achieved at the interface between the adjacent parts to the primary sealing member.

More preferably, the interface is lapped.

More preferably, the interface is harden-coated.

More preferably, the interface allows for radial sliding movement between the faces at varying temperatures

More preferably, the sliding motion allows the seal face distortion to be controlled.

Preferably, the effective secondary seal is preferably lapped between (or including) 1-2 light bands.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 is a cross-sectional view of the prior art apparatus;

FIG. 2 is a cross-sectional view of an embodiment of a mechanical seal in accordance with the present invention;

FIG. 3 is a detailed view from of the mechanical seal of FIG. 2;

FIG. 4 is a detailed view of the mechanical seal of FIG. 2 showing an alternative design with a hard coating; and,

FIG. 5 is a detailed view of mechanical seal of FIG. 2 showing an alternative design incorporating drive lugs within the face retainer.

### DETAILED DESCRIPTION OF THE DRAWING FIGURES AND PREFERRED EMBODIMENTS

The invention will now be described, by way of example only, with reference to the accompanying drawings:

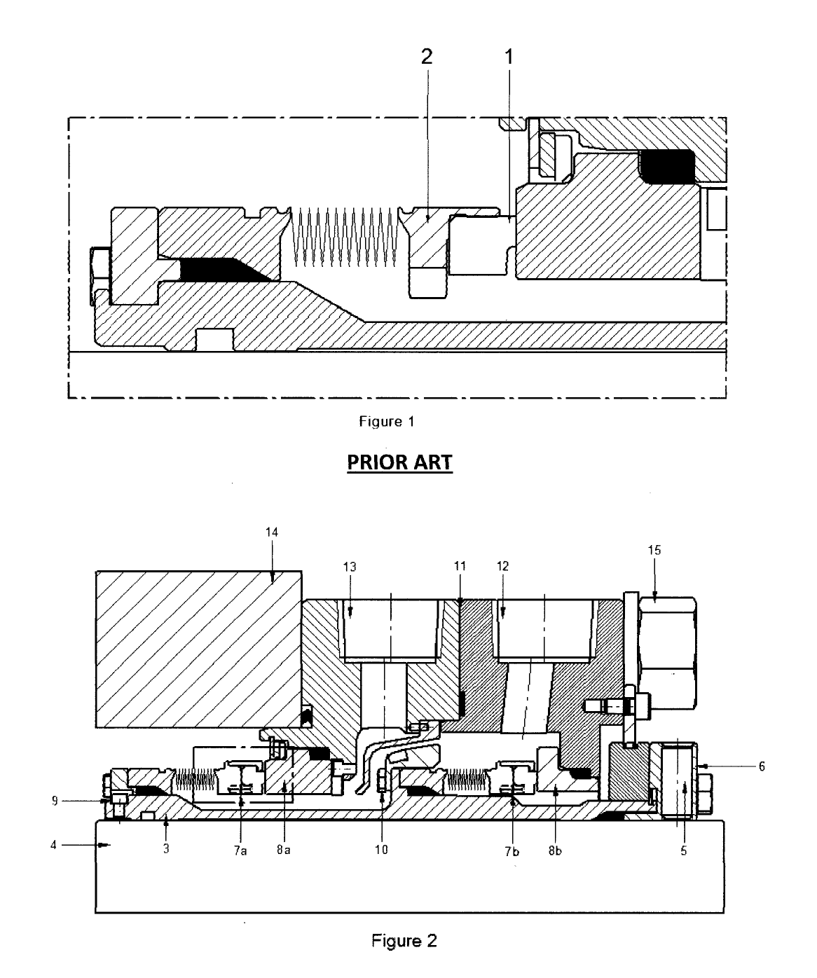

Turning now, in detail, to the accompany drawing figures, with respect to FIG. 1, there is shown the prior art. The primary sealing member 1 is held within its holder 2 via an interference fit. The holder 2 is constructed from a material which has a similar coefficient of thermal expansion to the primary sealing member 1. However, there is still a minor difference in the coefficient of thermal expansion of the face of the primary sealing member 1 and the holder 2, which leads to loss of seal integrity at varying temperatures. The material which is commonly selected for the holder 2 is also not corrosive-resistant against substances being pumped.

Referring to FIG. 2, there is shown the sleeve 3 which is detachably attached to the shaft 4 by means of a plurality of grub screws 5. The grub screws are housed within a clamp ring 6 and provide rotational drive to the sleeve 3 and rotational sealing members 7a, 7b. A seal is created via the stationary sealing members 8a, 8b being in contact with the rotational sealing members 7a, 7b. The inboard rotational sealing member 7a is provided with a driving force by a drive pin 9. The outboard rotational sealing member 7b is provided with drive by a plurality of bolts 10, which are fastened to the shaft 3. All the aforementioned parts are housed within the one or more glands 11. Within the one or more glands 11 there are housed barrier/buffer ports 12, 13, which allow both the inboard and outboard sealing members 7a, 7b, 8a, 8b to be cooled via a seal support system. The one or more glands 11 are then fastened to a housing 14 via another (or second) plurality of bolts 15.

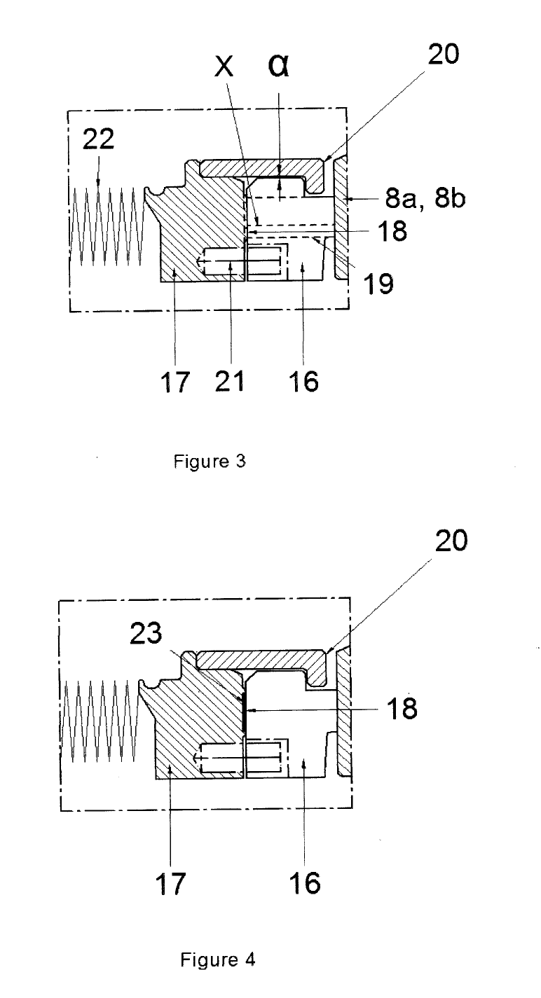

Now referring to FIG. 3 of the accompanying drawings, there is shown a detailed view of the rotary sealing members 7a, 7b. The primary rotary sealing member 16 is axially adjacent to the face aligning drive unit 17. The face aligning drive unit 17 is in contact with the primary rotary sealing member 16 via a lapped surface 18. The lapped surface 18 is designed so that it is in line with the sealing width 19 of the primary rotary sealing member 16 in order to maintain seal balance. The position of alignment 19 can be altered to varying positions (X) to change the face loading or balance of the primary rotary sealing member 16. The lapped surface 18 is allowed to move when thermal expansion occurs, which inhibits any distortion of the primary rotary sealing member 16. An annular retainer 20, both axially and radially, retains the primary rotary sealing member 16 via its wrap-around profile. The annular retainer is an interference fit onto the face aligning drive unit 17 and offset (α) from the outer diameter of the primary rotary sealing member 16. The offset (α) is created to allow for thermal expansion of the primary rotary sealing member 16. The annular retainer 20 and the face aligning drive unit 17 are created from like materials with identical coefficients of thermal expansion to ensure that they expand at the same rates to maintain contact at their interference. The face aligning drive unit 17 drives the primary rotary sealing member through a series of drive pins 21. All of the aforementioned parts are energized commonly via a bellow arrangement 22 to create a positive seal against the stationary sealing members 8a, 8b.

Referring to FIG. 4 of the accompanying drawings, there is shown an alternate iteration, or alternatively preferred embodiment of the present invention. The lapped section 18 is coated 23 to enhance seal performance between the face aligning drive unit 17 and the primary rotary sealing member 16. Commonly, the coating 23 is made from a hardened material.

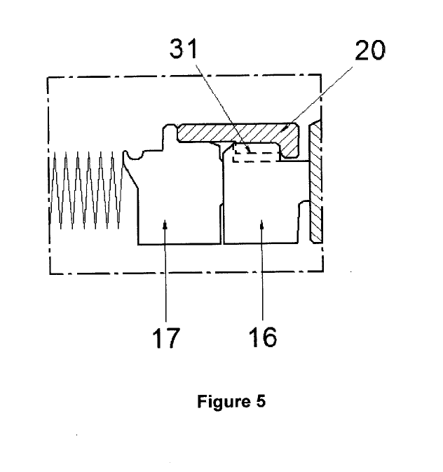

Finally, with reference to FIG. 5 of the accompanying drawings, there is shown an alternate iteration, or alternatively preferred embodiment of the present invention. The drive pins 21 can be replaced with an internal driving lug 31 in order to drive the primary rotary sealing member 16.

While only several embodiments of the present invention have been shown and described, it will be obvious to those skilled in the art that many modifications may be made to the present invention without departing from the spirit and scope thereof.

What is claimed is:

1. A mechanical seal assembly for sealing a rotatable shaft to a fixed housing, comprising:
a rotary component comprising a rotational sealing member;
a stationary component comprising a stationary sealing member;
a drive unit axially adjacent one of said rotational sealing member and said stationary sealing member;
an energizing member in contact with, and urging, said drive unit toward said rotational sealing member and said stationary sealing member; and,
a retainer located on said drive unit and said one of said rotational sealing member and said stationary sealing member for axially and radially retaining one of said rotational sealing member and said stationary sealing member,
wherein said drive unit is in contact with said one of said rotational sealing member and said stationary sealing member via contacting surfaces in a range of 1 and 20 light bands of flatness, inclusive.

2. The mechanical seal assembly according to claim 1, wherein said contacting surfaces have a concave shape, a convex shape or a concave/convex shape.

3. The mechanical seal assembly according to claim 1, wherein said retainer has an annular shape.

4. The mechanical seal assembly according to claim 1, wherein said retainer is split into a plurality of sections.

5. The mechanical seal assembly according to claim 1, wherein an inner diameter of said retainer is radially offset from an outer diameter of one of said rotational sealing member and said stationary sealing member.

6. The mechanical seal assembly according to claim 5, wherein said offset allows for radial thermal expansion of a primary sealing member.

7. The mechanical seal assembly according to claim 5, wherein said offset allows for axial thermal expansion of a primary sealing member.

8. The mechanical seal assembly according to claim 1, wherein said retainer is adjoined to said drive unit.

9. The mechanical seal assembly according to claim 8, wherein said retainer is an interference fit with said drive unit.

10. The mechanical seal assembly according to claim 8, wherein said retainer is connected to said drive unit via a shrink fit.

11. The mechanical seal assembly according to claim 8, wherein said retainer is connected to said drive unit via a thread.

12. The mechanical seal assembly according to claim 8, wherein said retainer is connected to said drive unit via an adhesive.

13. The mechanical seal assembly according to claim 8, wherein said retainer is connected to said drive unit via a weld.

14. The mechanical seal assembly according to claim 1, wherein said contacting surfaces are through both faces being lapped.

15. The mechanical seal assembly according to claim 1, wherein said contacting surfaces are harden-coated.

16. The mechanical seal assembly according to claim 1, wherein said contacting surfaces allow for sliding movement therebetween at varying temperatures.

17. The mechanical seal assembly according to claim 16, wherein said sliding movement allows for controlling seal face distortion.

18. The mechanical seal assembly according to claim 1, wherein said contacting surfaces are lapped in a range of 1-2 light bands, inclusive.
